(19) United States
(12) Patent Application Publication
(10) Pub. No.: US 2011/0133002 A1
(43) Pub. Date: Jun. 9, 2011

(54) INJECTION VALVE MEMBER

(76) Inventors: Thomas Kuegler, Korntal-Muenchingen (DE); Markus Krasemann, Bad Lippspringe (DE); Horst Opielka, Stuttgart (DE); Wilhelm Christ, Ludwigsburg (DE); Predrag Nunic, Stuttgart (DE); Thilo Kreher, Korntal-Muenchingen (DE); Friedrich Moser, Ludwigsburg (DE); Guenther Kubalik, Marbach (DE); Herbert Hoelzl, Wolfsberg (AT); Andreas Koeninger, Neulingen-Goebrichen (DE); Kerstin Kling, Ludwigsburg (DE)

(21) Appl. No.: 12/737,749

(22) PCT Filed: Jun. 30, 2009
(86) PCT No.: PCT/EP2009/058192

§ 371 Date: Feb. 11, 2011

(30) Foreign Application Priority Data
Aug. 11, 2008 (EP) 10 2008 041 165.5

(51) Int. Cl. F02M 61/12; F16K 25/00

(52) U.S. Cl. 239/584; 251/356; 251/368

(57) ABSTRACT

The invention relates to an injection valve member for a fuel injector, which injection valve member is of multi-part design and which has different functional regions. To reduce the production costs for a fuel injector having an injection valve member, the injection valve member includes two guide bodies which are fastened to a separate connecting rod.

The invention relates to an injection valve member for a fuel injector, which is embodied in multiple parts and includes different functional regions.

### PRIOR ART

From Published German Patent Application DE 10 2004 028617 A1, a nozzle needle for a fuel injector is known, having a guide portion that is provided with a layer of sintered metal. The known nozzle needle includes a nozzle needle base body, which essentially has the shape of a hollow cylinder. A sintered metal nozzle needle end is secured to the nozzle needle base body by shrinkage or press-fitting.

### DISCLOSURE OF THE INVENTION

It is the object of the invention to reduce the production costs for a fuel injector that has having an injection valve member which is embodied in multiple parts and includes different functional regions.

In an injection valve member for a fuel injector, which is embodied in multiple parts and includes different functional regions, this object is attained in that the injection valve member includes two guide bodies, which are secured to a separate connecting rod. The injection valve member is also called a nozzle needle. The present invention relates to relatively long nozzle needles, which are guided at two points in an injector housing of the fuel injector. In an essential aspect of the invention, the nozzle needle is constructed in modular fashion and includes two separate guide bodies, which can be used with different connecting rods, in particular with connecting rods of different lengths. As a result, in a simple way, it becomes possible to furnish a construction kit with different injector lengths.

A preferred exemplary embodiment of the injection valve member is characterized in that the connecting rod is formed of a different material from the guide bodies. The connecting rod is preferably formed from a material which ensures high axial stiffness of the connecting rod. The guide bodies by comparison are preferably formed from a material that has high wear resistance.

A preferred exemplary embodiment of the injection valve member is characterized in that the connecting rod is formed of a ceramic material, a simple structural steel that is readily weldable, a plastic material, and/or a casting material. The connecting rod can be formed entirely of one of the materials named. However, it is also possible for the connecting rod to be formed of different materials. The connecting rod can also have axial portions which are formed, at least in part, of different materials. In an essential aspect of the invention, the connecting rod is embodied in such a way that it can be manufactured in a simple way in different lengths and furnished as needed from stock on hand.

A preferred exemplary embodiment of the injection valve member is characterized in that the guide bodies are formed of a ceramic material, a plastic material, a sintered material, and/or a steel preferably hardened on the peripheral layer. The guide bodies can be formed entirely of one of the materials named. However, it is also possible for the guide bodies to be formed from different materials. In particular, the guide bodies can be especially treated and/or coated on guide faces.

A preferred exemplary embodiment of the injection valve member is characterized in that the injection valve member includes a tip, which is secured to the separate connecting rod. The tip has a sealing function and is formed, at least in part, of a preferably especially wear-resistant material.

A preferred exemplary embodiment of the injection valve member is characterized in that one of the guide bodies is connected in one piece to a tip. The guide body having the tip can be used with different connecting rods, especially connecting rods of different lengths, and the further guide body in a construction kit.

A preferred exemplary embodiment of the injection valve member is characterized in that the connecting rod has the form of a solid or hollow, straight circular cylinder. As a result, ‘it becomes possible in a simple way to produce connecting rods and furnish them as needed from stock on’ hand. However, the connecting rods can also have regions with different outside diameters. Moreover, at least one collar, which for example has a contact face for a closing spring, can be provided on the connecting rods.

A preferred exemplary embodiment of the injection valve member is characterized in that the guide bodies has the form of a solid or hollow, straight circular cylinder. In the axial direction, the guide bodies preferably have a markedly lesser extent than the connecting rod. The jacket face of the guide bodies represents a guide face, with which the respective guide body is guided, movably back and forth in the axial direction, in a guide bore or guide bore portion of the fuel injector. Preferably, flattened faces are provided on one of the guide bodies, and they make the passage of fuel in the vicinity of the guide possible.

A preferred exemplary embodiment of the injection valve member is characterized in that the connecting rod extends through at least one of the guide bodies. For that purpose, the guide body has a central through hole, whose diameter is adapted to the diameter of the connecting rod. The connection between the guide body, and the connecting rod can be embodied in force-locking, form-locking or material-locking fashion.

A preferred exemplary embodiment of the injection valve member is characterized in that at least one end of the connecting rod is disposed inside one of the guide bodies. This end can be connected to the guide body in force-locking, form-locking or material-locking fashion. Moreover, this end can alternatively or in addition be connected to one end of a peg on the other end of which a tip is provided.

A preferred exemplary embodiment of the injection valve member is characterized in that a middle part between the two guide bodies is embodied as variably long and/or rigid for the sake of making a construction kit with different fuel injectors, for instance of different lengths, which include injection valve members for instance with different lengths and/or different axial stiffness. In an essential aspect of the invention, a construction kit with different fuel injectors is furnished. By varying the middle part, the construction kit can be implemented especially economically.

The invention further relates to a fuel injector for reservoir-type injection systems, for injecting fuel, subjected to high pressure, into a combustion chamber of an internal combustion engine, having an injector housing, in which an injection valve member as described above is movable back and forth, in order to control an injection of fuel, subjected to high pressure, from the fuel injector into a combustion chamber of an internal combustion engine. In an essential aspect of the invention, the invention relates to a construction kit for a fuel injector with injection valve members, which include guide bodies that can be combined in a simple way with various connecting rods, and in particular connecting rods of different lengths.

Further advantages, characteristics and details of the invention will become apparent from the ensuing description, in which various exemplary embodiments are described in detail in conjunction with the drawings.

### BRIEF DESCRIPTION OF THE DRAWINGS

Shown are:

FIG. 1, a highly simplified illustration of a fuel injector with an injection valve member, in longitudinal section;

FIG. 2, a highly simplified illustration of an injection valve member in longitudinal section, with different functional regions; and

FIG. 3 through 12, injection valve members in longitudinal section, which are embodied in accordance with various exemplary embodiments of the invention.

### DESCRIPTION OF THE EXEMPLARY EMBODIMENTS

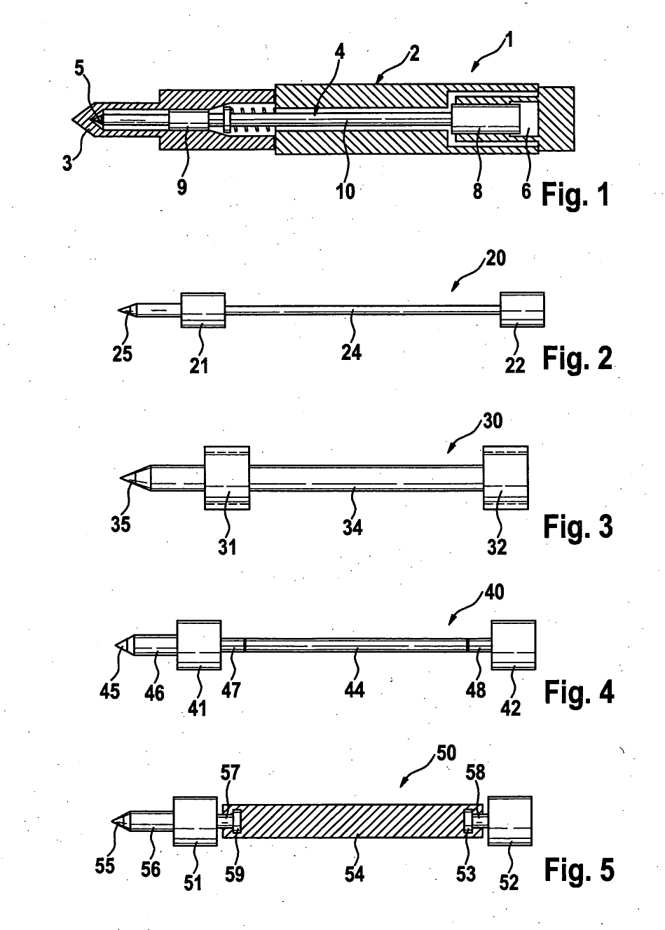

In FIG. 1, a fuel injector 1 with an injector housing 2 is shown, highly simplified, in longitudinal section. The injector housing 2 is embodied in multiple parts and protrudes into a combustion chamber of an internal combustion engine with its end 3 near the combustion chamber. In the injector housing 2, an injection valve member 4, also known as a nozzle needle, is guided movably back and forth. On its end remote from the combustion chamber, the injection valve member 4 has a tip 5 with a sealing edge, which can come to rest on a sealing face of the injector housing. When the sealing edge on the tip of the nozzle needle is in contact with the associated sealing face, then the fuel injector 1 is closed. If the pressure in a control chamber 6 on the end of the nozzle needle 4 remote from the combustion chamber is intentionally lowered, then the nozzle needle 4 opens, and the tip 5 with the sealing edge lifts from the associated sealing face, to enable a fluidic communication from a pressure chamber in the interior of the injector housing 2 into the combustion chamber.

On its end remote from the combustion chamber, the injection valve member 4 has a guide and/or sealing portion 8, through which the injection valve member 4 is guided at a first guidance point in the injector housing 2. At a second guidance point, the nozzle needle 4 is guided in the injector housing 2 with the aid of a guide and/or conduction portion 9. On the guide and/or conduction portion 9, flattened faces may be provided, which make it possible for fuel to pass through.

In an essential aspect of the invention, the two portions or faces 8, 9 are embodied on separate guide bodies, both of which are secured to a common connecting rod 10.

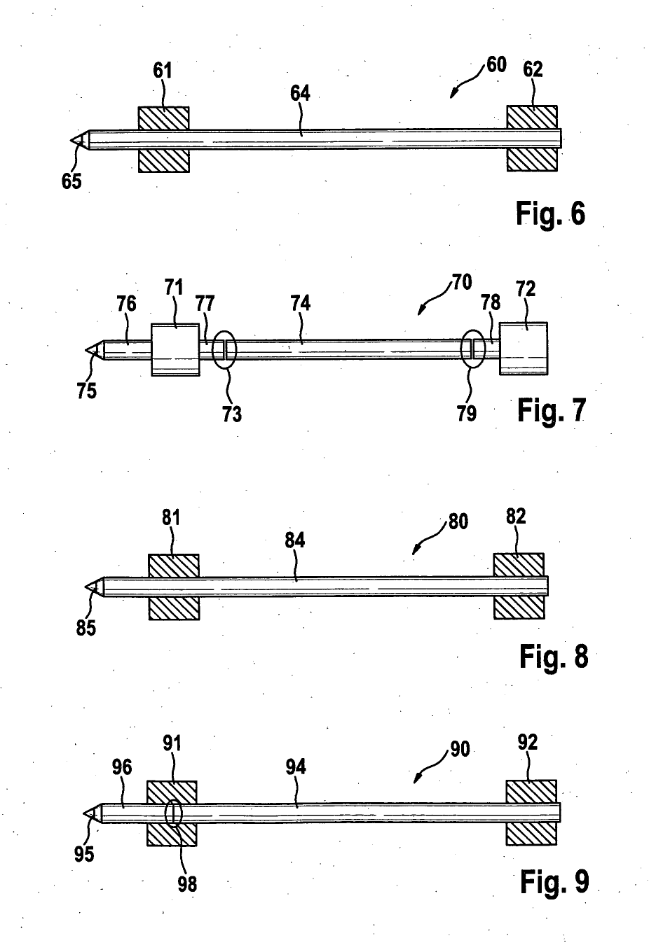

In FIG. 2, an injection valve member 20 is shown by itself in longitudinal section; it is similar to the injection valve member 4 of FIG. 1. The injection valve member 20 or nozzle needle 20 includes two guide bodies 21, 22, which are secured to the ends of a connecting rod 24. A tip 25 is secured to the guide body 21, on the face end remote from the connecting rod 24. The tip 25 may also be joined in one piece to the guide body 21. The tip 25 has the function of sealing. The guide body 21 has the functions of guiding and optionally of conducting fuel. The connecting rod 24 has the function of connecting. One essential aspect is whether the connecting rod 24 changes its length during operation. The guide body 22 has the functions of guiding and sealing.

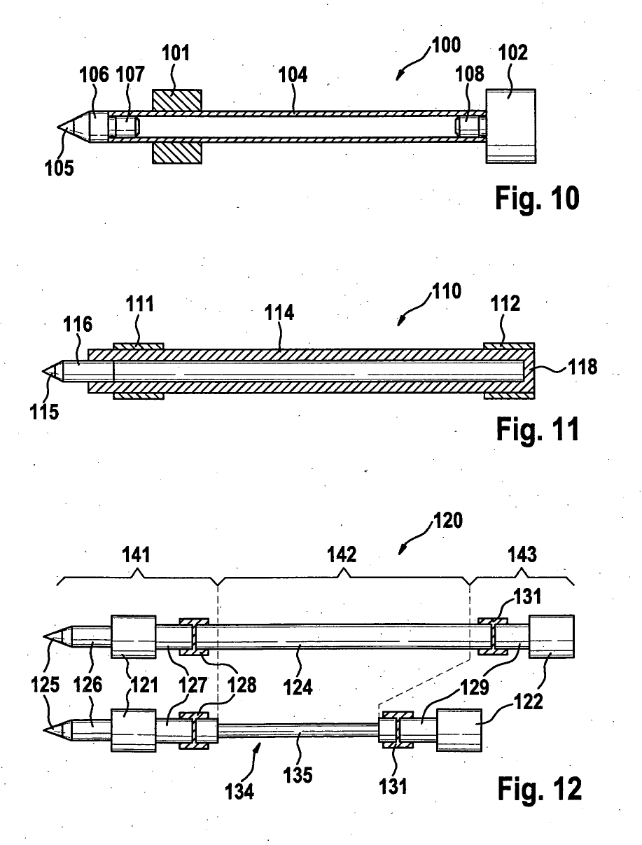

In FIG. 3, a nozzle needle 30 is shown, with two guide bodies 31, 32 that are secured to a connecting rod 34. A tip 35 is secured to the guide body 31. To increase their wear resistance, the guide bodies 31, 32 are provided with a wear-resistant coating. Moreover, the tip 25 is likewise provided with a wear-resistant coating.

In FIG. 4, a nozzle needle 40 is shown, with two guide bodies 41, 42 that are secured to the ends of a connecting rod 44. The connecting body 41 is joined in one piece to a tip 45 via a connecting portion 46. On the other side, a stump 47 extends from the guide body 41; the free end of the stump is secured to the connecting rod 44. A similar stump 48 begins at the guide body 42 and serves to secure it to the other end of the connecting rod 44. The connecting rod 44 has the form of a straight solid cylinder and is preferably formed from a ceramic material, a simple structural steel that is readily weldable, or a plastic. The guide bodies 41, 42 are preferably formed from a ceramic material, a plastic, a sintered material, or a steel hardened on the peripheral layer.

In FIG. 5, a nozzle needle 50 is shown, with two guide bodies 51, 52 which are secured to a connecting rod 54. The guide body 51 is joined in one piece to a tip 55 by means of a connecting portion 56. The connecting rod 54 is formed from a casting material. In a further aspect of the invention, the securing of the guide bodies 51, 52 to the connecting rod 54 is done by integral casting. For that purpose, a stump 57 begins at the guide body 51, and a collar 59 is embodied on its end. Analogously, a stump 58, on whose end a collar 53 is embodied, begins at the guide body 52. The collar 53, 59 and part of the associated stump 58, 57 is cast with the casting material from which the connecting rod 54 is formed. As the casting material, a steel or aluminum casting material may be used.

In FIG. 6, an injection valve member 60 is shown in longitudinal section; it has two guide bodies 61, 62, both of which have a central through hole through which a connecting rod 64 extends. A tip 65 is embodied on one end of the connecting rod 64. The two guide bodies 61, 62 can be secured on the connecting rod 64 by means of a press-fit connection. Alternatively, the two guide bodies 61, 62 could be connected in material-locking fashion to the connecting rod 64.

In FIG. 7, an injection valve member 70 is shown that is similar to the injection valve member 40 of FIG. 4. The injection valve member 70 includes two guide bodies 71, 72, which are secured to a connecting rod 74. A tip 75 is joined in one piece to the guide body 71 by means of a connecting portion 76. At a first parting point 73, one end of the connecting rod 74 is secured to a stump 77, which in turn is secured to the guide body 71. A further stump 78 is secured to the guide body 72 and connected in turn to the connecting rod 74 at a further parting point 79.

In FIG. 8, an injection valve member 80 is shown, which is similar to the injection valve member 60 of FIG. 6: The injection valve member 80 includes two guide bodies 81, 82, which are secured to a continuous connecting rod 84. A tip 85 is embodied on one end of the connecting rod 84. The guide bodies 81, 82 are preferably formed from plastic or a metal alloy, in particular having the designation 100 Cr6.

In FIG. 9, an injection valve member 90 is shown, with two guide bodies 91, 92 that are secured to a connecting rod 94. The two guide bodies 91, 92 each include a central through hole. The connecting rod 94 extends by its end remote from the combustion chamber through the guide body 94. The end of the connecting rod 94 near the combustion chamber is disposed, viewed in the axial direction, approximately in the middle of the guide body 91. An end remote from the combustion chamber of a peg 96 is located on the end, near the combustion chamber, of the connecting rod 94, and a tip 95 is embodied on the end of the peg nearer to the combustion chamber. The peg 96 is joined, preferably in material-locking fashion, to the connecting rod 94 and/or the guide body 91 at a parting point 98. In that case, the guide body 91 simultaneously acts as a connecting member between the connecting rod 94 and the peg 96 having the tip 95.

In FIG. 10, an injection valve member 100 is shown in longitudinal section, with two guide bodies 101, 102 that are secured to a connecting rod 104. The connecting rod 104 has the form of a straight hollow cylinder, which is open on both ends. A tip 105 is slipped onto the end toward the combustion chamber of the connecting rod 104. The tip 105 is joined in one piece, via a connecting portion 106, to a peg 107 that is disposed in the connecting rod 104. The guide body 101 includes a central through hole, through which the connecting rod 104 extends. A central peg 108 begins at the guide body 102 and is inserted into the end, remote from the combustion chamber, of the connecting rod 104. The securing of the tip 105 and of the guide bodies 101, 102 to the connecting rod 104 can be done in material-locking, form-locking or force-locking fashion.

In FIG. 11, an injection valve member 110 with two guide bodies 111, 112 is shown in longitudinal section. The two guide bodies 111, 112 have the form of sleeves, which extend around a connecting rod 114 that has the shape of a straight hollow cylinder. The connecting rod 114 is closed on its end 118 remote from the combustion chamber and is open on its end toward the combustion chamber. A tip 115 is inserted into the open end, toward the combustion chamber, of the connecting rod 114, and a peg 116 begins at the tip and is disposed partly in the connecting rod 114.

In FIG. 12, an injection valve member 120 in two different lengths is shown. The injection valve member 120 includes two guide bodies 121, 122, which can be secured to different connecting rods 124, 134. The guide body 121 has a tip 125, which by means of a connecting portion 126 is joined in one piece to the guide body 121. A stump 127 begins at the face end, remote from the tip 125, of the guide body 121 and is secured, with the aid of a connecting cuff 128, to the end toward the combustion chamber of the connecting rod 124, 134. An analogous stump 129 begins at the face end, toward the combustion chamber, of the guide body 122. The end of the stump 127 toward the combustion chamber is secured to the end, remote from the combustion chamber, of the connecting rod 124, 134 with the aid of a further connecting cuff 131.

For one thing, the connecting rod 134 is shorter than the connecting rod 124. Moreover, the connecting rod 134 includes a reduced-diameter region 135, which has a lesser outside diameter than the connecting rod 124.

In a further essential aspect of the invention, the axial stiffness of the injection valve member or nozzle needle can be adjusted in a targeted way. The axial stiffness has a substantial effect on the injector function, such as its opening speed, least-quantity capability, etc. In a further essential aspect of the invention, in a simple way, it becomes possible to create a construction kit with fuel injectors that are of different lengths. Because of the modular construction, according to the invention, of the nozzle needle, it is economically possible to furnish different lengths of the nozzle needle. The connecting rod 10; 24; 34; 44; 54; 64; 74; 84; 94; 114; 124; 134 essentially has the task of connecting the two guide bodies 21, 22; 31, 32; 41, 42; 51, 52; 61, 62; 71, 72; 81, 82; 91, 92; 101, 102; 111, 112; 121, 122 to one another and/or to the nozzle needle tip 25; 35; 45; 55; 65; 75; 85; 95; 115; 125. The connecting rod contributes substantially to the overall stiffness of the nozzle needle in the axial direction. The nucleus of the invention is the decoupling of the functional regions of the nozzle needle tip and guide bodies from the construction-kit-dependent parameters of needle length and axial stiffness.

Adjusting the requisite length and axial stiffness is done solely in one component, the connecting rod, while the functional regions of the nozzle needle tip and guide bodies remain unchanged. This concept offers the following advantages, among others: More parts that are identical, which has a favorable effect on logistics and costs; and variation in a relatively simple component, with less-stringent demands for precision and tolerances, which has a favorable effect on costs. Moreover, it is possible to produce the connecting rod from a different material, which has a favorable effect on costs and may have advantages for a desired connecting technique.

It is indicated in FIG. 12 that the total stiffness of the nozzle needle 120 is composed of the individual stiffnesses of the components 141, 142 and 143. The axial stiffness is dependent on the various cross-sectional areas and the length of the associated component and on the modulus elasticity. In a longer variant, the axial stiffness of the nozzle needle 120 can be kept constant, if the individual stiffnesses 141 through 143 of the components remain constant. Since the components 141 and 143 are always kept geometrically identical, the associated stiffnesses are also constant. Accordingly, the stiffness of the component 142 having the connecting rod 124; 134 must remain constant as well. This is possible if the ratio of the cross-sectional area and length of the connecting rod 124; 134 is kept constant.

The connecting rod 124; 134 can be embodied as a solid cross section of rod material or as a hollow cross section of tubular material. Embodying the connecting rod 124; 134 as a hollow cross section can have both functional advantages and advantages in terms of production technology. The diameter at the joining points should remain constant, as is shown in FIG. 12, from the standpoint of process technology and for the sake of strength that remains constant for all the variants of the connecting rod 124; 134. For a solid cross section, this may mean an offset to a smaller and/or larger diameter. In a hollow cross section, the adaptation of the cross-sectional area can be done by way of the inside diameter, while the outside diameter can remain constant.

1-12. (canceled)

13. An injection valve member for a fuel injector, which is embodied in multiple parts and includes different functional regions, the injection valve member comprising two guide bodies which are secured to a separate connecting rod.

14. The injection valve member as defined by claim 13, wherein the connecting rod is formed of a different material from the guide bodies.

15. The injection valve member as defined by claim 13, wherein the connecting rod is formed of a ceramic material, a simple structural steel that is readily weldable, a plastic material, and/or a casting material.

16. The injection valve member as defined by claim 14, wherein the connecting rod is formed of a ceramic material, a simple structural steel that is readily weldable, a plastic material, and/or a casting material.

17. The injection valve member as defined by claim 13, wherein the guide bodies are formed of a ceramic material, a plastic material, a sintered material, and/or a steel preferably hardened on the peripheral layer.

18. The injection valve member as defined by claim 14, wherein the guide bodies are formed of a ceramic material, a plastic material, a sintered material, and/or a steel preferably hardened on the peripheral layer.

19. The injection valve member as defined by claim 15, wherein the guide bodies are formed of a ceramic material, a plastic material, a sintered material, and/or a steel preferably hardened on the peripheral layer.

20. The injection valve member as defined by claim 16, wherein the guide bodies are formed of a ceramic material, a plastic material, a sintered material, and/or a steel preferably hardened on the peripheral layer.

21. The injection valve member as defined by claim 13, wherein the injection valve member includes a tip, which is secured to the separate connecting rod.

22. The injection valve member as defined by claim 20, wherein the injection valve member includes a tip, which is secured to the separate connecting rod.

23. The injection valve member as defined by claim 13, wherein one of the guide bodies is connected in one piece to a tip of the injection valve member.

24. The injection valve member as defined by claim 14, wherein one of the guide bodies is connected in one piece to a tip of the injection valve member.

25. The injection valve member as defined by claim 15, wherein one of the guide bodies is connected in one piece to a tip of the injection valve member.

26. The injection valve member as defined by claim 17, wherein one of the guide bodies is connected in one piece to a tip of the injection valve member.

27. The injection valve member as defined by claim 13, wherein the connecting rod is embodied as a solid or hollow, straight circular cylinder.

28. The injection valve member as defined by claim 13, wherein the guide bodies is embodied as a solid or hollow, straight circular cylinder.

29. The injection valve member as defined by claim 13, wherein the connecting rod extends through at least one of the guide bodies.

30. The injection valve member as defined by claim 13, wherein at least one end of the connecting rod is disposed inside one of the guide bodies.

31. The injection valve member as defined by claim 13, wherein a middle part between the two guide bodies is embodied as variably long and/or rigid for making a construction kit with different fuel injectors, for instance of different lengths, which include injection valve members for instance with different lengths and/or different axial stiffnesses.

32. A fuel injector for reservoir-type injection systems, for injecting fuel, subjected to high pressure, into a combustion chamber of an internal combustion engine, having an injector housing, in which an injection valve member as defined by claim 13 is movable back and forth, in order to control an injection of fuel, subjected to high pressure, from the fuel injector into a combustion chamber of an internal combustion engine.
